(19) United States
(12) Patent Application Publication
(10) Pub. No.: US 2023/0409679 A1
(43) Pub. Date: Dec. 21, 2023

(54) SYSTEMS AND METHODS FOR A TOKENIZED VIRTUAL PERSONA FOR USE WITH A PLURALITY OF SOFTWARE APPLICATIONS

(71) Applicant: DREAMCHAIN CORPORATION, Laguna Woods, CA (US)

(72) Inventors: Michael G. Rubin, Laguna Woods, CA (US); Raghuram Balasubramanian, Santa Ana, CA (US)

(73) Assignee: DREAMCHAIN CORPORATION, Laguna Woods, CA (US)

(21) Appl. No.: 18/451,803

(22) Filed: Aug. 17, 2023

Related U.S. Application Data
(63) Continuation of application No. PCT/US2022/018024, filed on Feb. 25, 2022.
(60) Provisional application No. 63/154,597, filed on Feb. 26, 2021.

(51) Int. Cl. G06F 21/10; H04L 9/30; H04L 9/32

(52) U.S. Cl. CPC G06F 21/1014; H04L 9/3073; H04L 9/3213; H04L 9/3231; G06F 21/1074

(57) ABSTRACT

Systems and methods for securely managing all aspects of virtual personas, i.e., all aspects of digital representations of any human, animal or character used to represent an object in any software application. The systems and methods securely manage the creation of virtual personas, the encryption and tokenization of the virtual personas, recordation of the tokenized virtual personas on a distributed ledger technology, the authorization of software applications to access and use the virtual personas, the modification of the virtual personas, the ownership rights in the virtual personas, the grant of access and usage rights in the virtual personas to other parties, providing authorized access and use of the virtual personas, and the ability of character intellectual property owners to create and license virtual personas based on proprietary characters.

### CROSS REFERENCE TO RELATED APPLICATIONS

The present application is a continuation of International Patent Application No. PCT/US2022/018024, filed on Feb. 25, 2022, pending, which claims the benefit of priority of U.S. provisional patent application No. 63/154,597, filed Feb. 26, 2021. The entire disclosures of the above applications are expressly incorporated by reference

### FIELD OF THE INVENTION

The present invention relates generally to virtual personas used in software applications such as games, and more particularly, to systems and methods for securely creating, encrypting and tokenizing, and managing a virtual persona, including configuring ownership and control of the virtual persona for use on one or more of a plurality of different software applications and/or platforms.

### BACKGROUND OF THE INVENTION

Computer systems are becoming more capable of replicating the real world in digital formats with the rapid advancements of three-dimensional (3D) graphics processors (GPUs), digital scanning and computer vision technologies, machine learning and artificial intelligence. The intersection of these technological advances enables all new media types to be created that utilize standard two-dimensional (2D) image and video capture technologies which can be converted into 3D objects that provide photo-realistic levels of rendering.

At the same time, more and more computer applications are using 3D characters, avatars and 3D effects as part of the features they offer. Examples include advanced video games, including games utilizing Augmented Reality (AR) and/or Virtual Reality (VR), AR effects in social media, other VR applications and virtual worlds. VR is a computer technology that replicates an environment, which may be a simulation of a real-life environment or an imaginary environment, and simulates a user's presence in the environment allowing the user to interact with the environment. Current forms of VR are displayed on a computer display or with a special VR headset worn over the user's eyes, which provides visual and sound simulations of the VR experience. Some simulations also include additional sensory input, such as haptic/tactile feedback to the user to simulate various interactions with the VR environment. AR is similar to virtual reality in that it involves a computerized simulation, but differs in that AR utilizes a real-world environment in which certain elements are augmented and/or supplemented by a computer-generated simulation of sensory input such as video, sound, graphics, and/or tactile feedback, and which simulates a user's presence in the environment allowing the user to interact with the environment. The user may interact with the AR or VR environments using standard computer input devices such as a keyboard and mouse, and also through multimodal devices such as gloves or other wearables having sensors to detect motion and forces, and/or external motion sensors which detect a user's position and motions. For purpose of the present description, the terms “VR” and “Virtual Reality” shall mean either, or both, VR and AR, unless specified otherwise.

Typically, currently available software applications contain their own systems of characters, avatars and 3D effects configured to be used within those specific applications. While users may be able to create and or customize their avatar, effect or other characters, they do not typically own these representations, and they generally are not capable of using these representations outside of the application in any other software application/platform (as used herein, the terms “software application” and “application” shall include both a software application and a software platform).

As users become more active in applications that allow them to use avatars and characters as representations of themselves, these representations may become virtual personas, i.e., a comprehensive digital representation of a human, animal, or character of any sort, which can be used in a computer software application. The virtual persona may be visual, audio, expressive, animated, controllable, autonomous, capable of machine learning, and/or any combination of the aforementioned. Combined with machine learning and artificial intelligence these virtual personas can take on real-world characteristics of speech, gestures, looks, vocabulary, personality, behaviors, capabilities, movements, preferences, etc.

Other technologies that are emerging are blockchain, digital ledgers and smart contracts. These systems allow for decentralization of data and records of ownership of data that can be registered and transacted using these systems. They remove any central organization from controlling or owning their users' data, and provides means to verify and track ownership rights and changes in ownership rights.

As these technologies and use cases continue to evolve and converge there exists a need for a secure virtual persona system. Currently available applications have virtual personas only usable within their own specific application, and the virtual personas are not accessible and usable by users or other third-party applications, such as games, VR games, etc. Hence, a user must create virtual personas for each application, and even then, the user does not have access to the virtual personas, and cannot control the virtual personas. For example, the providers of the applications own and control the virtual personas. This creates many problems, such as the inability to control, transfer, modify, sell, assign, or otherwise manage the user's virtual persona.

Accordingly, the present invention is directed to systems and methods which overcome the aforementioned limitations of current systems and methods of creating, managing and using virtual personas.

### SUMMARY

Generally, the present invention is directed to systems and methods for securely managing all aspects of virtual personas, i.e., all aspects of digital representations of any human, animal or character used to represent an object in any software application. For example, the systems and methods can securely manage the creation of virtual personas, the encryption and tokenization of the virtual personas, the authorization of software applications to access and use the virtual personas, the modification of the virtual personas, the ownership rights in the virtual personas, the grant of access and usage rights in the virtual personas to other parties, providing authorized access and use of the virtual personas, the ability of character intellectual property owners to create and license virtual personas based on proprietary characters, etc.

Accordingly, in one embodiment, the present invention is directed to a method for creating a tokenized virtual persona and securely managing access and use of the virtual persona. The method is performed on a virtual persona system comprising one or more computing systems hosting one or more software applications configured to perform the method. The computing system(s) each have one or more computer processors, memory, and one or more storage devices. The virtual persona system may be configured as a cloud computing system, a software as a service computing system, a peer-to-peer decentralized network of computing systems (i.e. nodes), or a stand-alone, local computing system.

The method includes creating a virtual persona for a first user. The virtual persona may be created by any suitable means, including without limitations the methods described herein. The virtual persona includes digital representations of one or more of appearance attributes, physical attributes, sound traits, capability traits and personality traits for the virtual persona. For instance, the virtual persona may be based on a digital image of the first user, such as a digital photo, digital video, or digital image of some other person, object, character, animal, etc. The digital image may then be modified by the system based on input from the user, or automatically by a software application. For instance, the digital image may be converted into a caricature, and/or modified from a 2D image to a 3D object.

The virtual persona is associated with a unique first user account. For instance, the first user account may be created by authenticating the first user, allowing the user to create the account. The first user account is associated with a unique authorized cryptographic key pair (ACKP). The ACKP may be an asynchronous cryptographic key pair including a private key and a public key. The account may then be registered on a distributed ledger technology (DLT). DLT is known by those of ordinary skill in the art, and generally refers to infrastructure and protocols that allow simultaneous access, validation, and record updating in an immutable manner across a network that is spread across multiple entities and/or locations. The DLT may be any suitable DLT, such as a blockchain technology, a directed acyclic graph (DAG) technology, etc.

The virtual persona is then encrypted to securely protect the virtual persona. The virtual persona may be encrypted using the first user's ACKP, or other suitable encryption technique. The encrypted virtual persona is stored at a storage location within a virtual persona files database. For example, the storage location may be a cloud storage system and the virtual persona files database may be a relational database configured to store encrypted virtual personas in association with their respective users and/or owners.

A master virtual persona token (MVPT) is generated for the virtual persona by associating the virtual persona and its storage location to the first user account as a non-fungible token (NFT). This is also referred to herein as “tokenizing” the virtual persona. The NFT may also be non-tradeable, i.e., non-transferable by the first user. As used herein, the terms “generating a token,” “tokenizing,” and “tokenization” refer to a process of substituting a data element (e.g., a virtual persona) with a non-sensitive equivalent, referred to as a token, which is infeasible to reverse back to the data element. In other words, tokenizing data, or “tokenization,” as is known in the art, and in the context of data security, is the process of substituting a sensitive element with a non-sensitive equivalent, referred to as a token, that has no extrinsic or exploitable meaning or value. The token is a reference (i.e., identifier) that maps back to the sensitive data through a tokenization system. The mapping from the original data to a token uses methods that render tokens infeasible to reverse in the absence of the tokenization system, for example by using tokens created from random numbers. A token is non-fungible where it is non-interchangeable with other tokens, and/or it cannot be subdivided for interchange with other tokens, on the DLT.

The MVPT is recorded on the DLT which is configured to track ownership rights to the virtual persona. Accordingly, the ownership of the virtual persona by the first user account is recorded, and can be verified on the DLT.

One or more permissions defining usage rights for the virtual persona are configured. The permissions are typically configured by the system according to input from the first user. The permissions include authorizing one or more of a plurality of software applications to access and use the virtual persona. For instance, the permissions may authorize a particular game platform to access and use the virtual persona on behalf of the first user. As discussed herein, the permissions may also include other types of usage rights, such as authorizing one or more other users to access and use the virtual persona and configuring the access rights, usage rights and restrictions on use for the one or more other users; and/or authorizing one or more other users to view the virtual persona and configuring the viewing rights and restrictions for the one or more other users.

The permissions are then recorded as a transaction for the MVPT on the DLT. This allows the system to verify a request and to configure the usage rights in response to a request to access and use the virtual persona. In another aspect, license terms for the access rights, usage rights and viewing rights granted to the one or more other users may be configured. The license terms may include the amount of payment and/or term of the license.

In another aspect, the method may further include authorizing access and use of the virtual persona to a requestor such as a software application. For instance, take the case that the first user wants to use the virtual persona on an online gaming platform. The gaming platform can include an interface, such as an application programming interface (API), or a login feature that accesses an API, or other means, to allow a user to access and use the virtual persona created and managed on the virtual persona system within the gaming platform. Accordingly, the method further includes receiving a request from a requestor software application to access the virtual persona on behalf of the first user. The request includes an authenticator generated using the first user's ACKP. The request to access the virtual persona is verified using the DLT by (a) verifying the requestor has permission to access the virtual persona in the permissions and (b) authenticating the authenticator using the ACKP. In other words, the virtual persona system determines whether the permissions in the MVPT stored on the DLT include authorizing the requestor software application to access the virtual persona, and also authenticates the authenticator using the ACKP (which also may be recorded in the MVTP on the DLT) to authenticate that the request was made by an authorized user (e.g., the first user). Authenticating a communication using an ACKP is known by those of ordinary skill in the art, and may including, for example, using a digital signature generated using the private key of the first user's ACKP.

Upon verifying the request to access the virtual persona, the requestor software application is allowed to access the virtual persona. This may be done by uploading or streaming the virtual persona from the storage location to the requestor software application. The requestor software application is also allowed to use the virtual persona only according to the usage rights as set forth in the permissions.

In still another aspect of the method, the virtual persona may be uploaded or streamed to the requestor in encrypted packets for rendering in real-time by the requestor without providing storage of the virtual persona. This provides further security for the virtual persona.

In yet another aspect, the method may further comprise recording a transaction on the DLT for allowing the requestor software application to access the virtual persona.

In another aspect, configuring the one or more permissions may also include other usage rights and restrictions, such as: authorizing one or more other users to access and use the virtual persona and configuring access rights, usage rights and restrictions on use for the one or more other users; and authorizing the one or more other users to view the virtual persona and configuring the viewing rights and restrictions for the one or more other users.

In still another aspect of the method, a smart contract software application (also referred to herein as a “smart contract”) may be used to generate the MVPT by associating the virtual persona to the first user account. A smart contract is known by those of ordinary skill in the art, and is a self-executing software program that binds an authenticated or permission user account with a virtual persona to generate an MVPT, i.e., a tokenized master virtual persona (MVP) which can be accessed by authentication using the ACKP.

In yet another aspect, the method may further comprise a secure process for creating the first user account. The process for creating the first user account may include authenticating an identity of the first user by transmitting an authentication message to a messaging address provided by the first user. For instance, the messaging address may be a mobile phone number or an email address of the user, such that the authentication message is a text message transmitted to the mobile phone number or an email sent to the email address. An authenticating response is received from the first user in response to the authentication message. The ACKP is then generated in response to receiving the authenticating response. An authorized and password-secured digital wallet is created for the first user and the ACKP is registered in the digital wallet of the first user. The first user's digital account wallet may then be used to generate an authenticator using the ACKP, for instance, when creating a request to access the virtual persona.

In another aspect of the method, the process for creating the first user account may further include verifying that the first user is a real person using a live image detection on a real-time photo capture device to eliminate fake users, including bots, and to prevent plagiarism of another user's identity. In another feature, the live image detection may be a single image, passive facial liveness detection system. Hence, the processes for creating a virtual persona, tokening the virtual persona, and creating a user account comprises a complete system of authenticating that the first user is the authenticated user of the device and a verified real person for the creation so that the account and the MVPT created are for the authenticated and real person.

In additional aspects, the method may include various processes for creating the virtual persona. In one process, a digital image of the user is received from the first user. The digital image may be a digital photo, a digital video, a digital scan, etc. The digital image is converted into three-dimensional avatar data thereby forming a virtual persona base (VPB). The VPB includes base digital files for constructing the virtual persona, including one or more of appearance attributes, physical attributes, sound traits, capability traits and personality traits for the virtual persona. In still another aspect, the VPB may be tokenized by generating a virtual persona attribute token by associating the VPB to the first user account as an NFT which documents ownership of the VPB by the first user (i.e., owner of the MVPT). The VPB token may then be registered on the DLT.

The process for creating the virtual persona may also include steps for modifying the VPB. In one way, a virtual persona attribute (VPA) may be added to the virtual persona, wherein the VPA is a digital object and/or data to change one or more of the appearance attributes, physical attributes, sound traits, capability traits and personality traits for the virtual persona. The VPA may be directly controllable only by an owner of the MVPT, user(s) authorized by the owner of the MVPT, and software applications authorized by the permissions.

In still another aspect, the VPA may be tokenized by generating a virtual persona attribute token by associating the VPA to the first user account as an NFT which documents ownership of the virtual persona attribute token by the first user (i.e., owner of the MVPT). The virtual persona modification token may then be registered on the DLT.

Similarly, in still another aspect, the VPB may be modified by adding a virtual persona modification (VPM) to the virtual persona, wherein the VPM is one or more of a digital object and data to change one or more of appearance attributes, physical attributes, sound traits, capability traits and personality traits for the virtual person. The VPM differs from a VPA in that the VPM can be used by anyone, but only as authorized by the first user (i.e., the owner of the MVPT).

In another aspect, the virtual persona modification can be tokenized by generating a virtual persona modification token by associating the VPM to the first user account as an NFT which documents ownership of the virtual persona modification token by the first user. The virtual persona modification token may then be registered on the DLT.

In another aspect, the virtual persona may be created from something other than an image of the first user. A digital image of a two-dimension or three-dimension source is captured. The source may be a photo, a video, a real-world animate object and a real-world inanimate object. The digital image is converted into three-dimensional avatar data thereby forming a virtual persona base (VPB). In another aspect, the digital image may be captured by digital scanning, computer vision or other suitable image capturing process which converts the source into a digital image file.

In yet another aspect of the method, the virtual persona may be created using a computer design software application to produce a set of digital files representing one or more of the appearance attributes, physical attributes, sound traits, capability traits and personality traits for the virtual persona. The computer design software may be manually operated by a user to create a virtual persona, semi-automated by user input and automated generation, or fully automated without user input.

In additional aspects, the method may include creating one or more additional virtual personas for the first user, referred to as sub virtual personas (SVPs), which are stored along with the MVP (i.e., the virtual persona) and which are similarly associated with the first user on the DLT, and which may have their own permissions distinct from the MVP. Hence, the method may also comprise configuring one or more permissions defining usage rights for the SVPs, same or similar to configuring permissions for the virtual persona. Furthermore, same or similar to the virtual persona, the SVP is associated with the first user account, encrypted, and stored in the virtual persona media files database. The SVP and its permissions are also registered within the MVPT on the DLT. In still another aspect, the SVP may be tokenized by generating an SVPT token (SVPT) by associating the SVP to the first user account as an NFT which documents ownership of the SVPT by the first user (i.e., owner of the MVPT). The SVPT may then be registered on the DLT.

In another aspect, the SVP may also be modified using a VPA or VPM and registered within the MVPT on the DLT, same or similar to modifying a virtual persona.

In another aspect, the method may include means for allowing a second user to access and use the virtual persona of the first user. This may be done by authorizing the second user via a permission and/or license agreement. The second user will have its own unique second user account and an associated unique second ACKP. Accordingly, a first permission is configured to authorize the second user to use the virtual persona. The first permission is recorded as a transaction on the DLT. A requestor software application makes a request to access the virtual persona on behalf of the second user. The request includes an authenticator generated using the second ACKP. The request is received and then verified using the DLT by verifying the requestor software application has permission to access the virtual persona in the application permissions, and authenticating the authenticator using the second ACKP.

In additional aspects of the method, the first user may be a character intellectual property owner (CIPO) that owns intellectual property rights in a character. For instance, the first user may be a movie studio which owns intellectual property rights in a superhero character, and is willing to license the character to one or more user to create virtual personas based on the character. In this case, the first user account is a CIPO account of the CIPO, and creating the virtual persona may comprise: (a) receiving a request from the CIPO account to create the virtual persona; (b) authenticating the request from the CIPO account using the ACKP; (c) receiving character data for the character comprising one or more of appearance attributes, physical attributes, sound traits, capability traits and personality traits for the character; and creating the virtual persona using the character data.

In another aspect of the method having a CIPO, the CIPO account may be created by authenticating an identity of the CIPO by transmitting an authentication message to a messaging address provided by the CIPO, and receiving an authenticating response from the CIPO in response to the message. The authentication message may be same or similar to the authentication message described above. The ACKP is generated in response to receiving the authenticating response. An authorized digital account wallet for the CIPO is created and the ACKP is registered in the digital account wallet of the CIPO.

In another aspect of the method, permissions are granted to allow other users to use the virtual persona based on the character data, and the second user is allowed to use the virtual persona on a software application. A permission to grant access rights to the virtual persona to a second user is configured. The second user has a unique second user account having an associated unique second ACKP. A request from a requestor software application to access the virtual persona on behalf of the second user is received. The request includes an authenticator generated using the second ACKP. The request to access the virtual persona is verified using the DLT by (a) verifying the requestor has permission to access and use the virtual persona in the permissions and (b) authenticating the authenticator using the second ACKP. Finally, upon verifying the request to access the virtual persona, the requestor software application is allowed to access the virtual persona and to only use the virtual persona as set forth in the permissions.

In yet more aspects, the virtual persona may be an SVP, and the CIPO may also create one or more SVPs, same or similar to the processes described above. For instance, an SVP may be created by using a VPA and/or a VPB.

In another aspect of the method, access and use rights may be granted to a sub virtual persona entity account. This may be useful when the first user desires to grant a license to access and use a virtual persona for the first user to another user. In this case, the method further includes creating a sub virtual persona (SVP) entity account and generating an SVP ACKP associated with the SVP entity account. An authorized SVP entity account wallet is created and the SVP ACKP is registered in the SVP entity account wallet. A permission is configured granting the SVP entity account access and use rights to the virtual persona for the first user. A SVP token (SVPT) is generated by associating the access rights to the virtual persona as a non-fungible token, and the SVPT is recorded as a transaction on the DLT. In another aspect, the SVPT may be generated by a smart contract which combines the SVPT ACKP with the storage location of the SVP.

Another embodiment of the present invention is directed to a CIPO method for creating a virtual persona based on a character owned by a CIPO, and securely managing access and use of the virtual persona. The CIPO method may be performed on the same or similar virtual persona system described above. The method includes creating a virtual persona utilizing character data for a character owned by a CIPO. The virtual persona comprises one or more of appearance attributes, physical attributes, sound traits, capability traits and personality traits for the virtual persona. The virtual persona is associated with a unique CIPO account having an associated unique ACKP. The virtual persona is encrypted and stored at a storage location within a virtual persona media database. A MVPT of the virtual persona is generated by associating the virtual persona to the CIPO account as an NFT. The MVPT is recorded as a transaction on a distributed ledger technology (DLT) configured to track ownership rights to the virtual persona. A license to a first user is configured to allow the first user to access and use the virtual persona. The license for the first user is recorded as a transaction for the MVPT on the DLT. A requestor software application makes a request to access the virtual persona on behalf of the first user, which is received. The request includes an authenticator generated using the ACKP. The request to access the virtual persona is verified using the DLT by verifying the first user has permission to access the virtual persona in the license, and authenticating the authenticator using the ACKP. Upon verifying the request to access the virtual persona, the requestor is allowed to access and the virtual persona.

In additional aspects of the CIPO method, access to the virtual persona may be provided by uploading or streaming the virtual persona to the requestor. In additional aspects, the virtual persona may be uploaded or streamed to the requestor in encrypted packets for rendering in real-time by the requestor without providing storage of the virtual persona.

In another aspect, the CIPO method may also including recording a transaction on the DLT for allowing the requestor software application to access the virtual persona. In still another aspect, the MVPT may be generated by a smart contract which associates the virtual persona to the CIPO account.

In another aspect of the CIPO method, the character data comprises one or more of appearance attributes, physical attributes, sound traits, capability traits and personality traits for the character. The method further comprises receiving a request from the CIPO account to create the virtual persona, authenticating the request from the CIPO account using the ACKP; and receiving the character data.

In another aspect of the CIPO method, the CIPO account is created by the following process: authenticating an identity of the CIPO by transmitting an authentication message to a messaging address provided by the CIPO, and receiving an authenticating response from the CIPO in response to the message; generating the ACKP in response to receiving the authenticating response; and creating an authorized digital account wallet for the CIPO and registering the ACKP in the digital account wallet of the CIPO. The messaging address may be any of the messaging address described above.

In another aspect, the virtual persona may be an SVP created by the CIPO. The SVP may be created by using one of following processes: (1) creating a VPA comprising a digital object or data which can be added to the virtual persona or to the SVP to change one or more of the appearance, sound, actions, and intelligence of the virtual persona or SVP via direct control of the first user and any software application authorized by the permissions, wherein the VPA is owned by the first user, and using the VPA to create the SVP; and (2) creating a VPM comprising a digital object or data which can be added to the virtual persona or to the SVP to change one or more of their appearance, sound, actions, and intelligence via any means authorized by the permissions, wherein the VPM is not owned by the first user, and using the VPM to create the SVP.

In still another aspect, the CIPO method may include the use of a sub virtual persona entity account. A sub virtual persona (SVP) entity account is created and an SVP ACKP associated with the SVP entity account is generated. An authorized SVP entity account wallet is generated and the SVP ACKP is registered in the SVP entity account wallet. A license to access the virtual persona for the first user is granted to the SVP entity account. An SVP token (SVPT) is generated by associating the license to the virtual persona as a non-fungible token. The SVPT is recorded as a transaction on the DLT. In another aspect, the SVPT may be generated by a smart contract which combines the SVPT ACKP with the storage location.

Another embodiment of the present invention is directed to a system for creating a tokenized virtual persona and securely managing access to and use of the virtual persona. The system may comprise the virtual persona system described above. The virtual persona system is embodied in one or more software applications installed and executing on one or more computing systems which may be networked together to operate as an integrated system. The software application and computing system are configured and programmed to perform any one or more of the method embodiments described above. Hence, in one embodiment, the virtual persona system includes a tokenized virtual persona system, a virtual persona container system, and a virtual persona access system. The tokenized virtual persona system is configured to:
create a virtual persona for a first user, the virtual persona comprising one or more of appearance attributes, physical attributes, sound traits, capability traits and personality traits for the virtual persona;
associate the virtual persona with a unique first user account having an associated unique authorized cryptographic key pair (ACKP); and
encrypt the virtual persona.

The virtual persona container system is configured to store the encrypted virtual persona at a storage location within a virtual persona files database. In another aspect, the virtual persona files database may include a virtual persona media database containing the media files for the virtual persona stored therein, and a virtual persona behaviors database for storing the data files for the capability traits and personality traits for the virtual personas.

The virtual persona access system comprising a virtual persona tokenization system and a virtual persona user control panel. The virtual persona tokenization system is configured to generate the MVPTs of the virtual personas by associating the respective virtual personas and permissions to the respective user accounts as respective NFTs. The virtual persona user control panel is configured to:
configure permissions defining usage rights for the virtual persona, the permissions including authorizing one or more of a plurality of software applications to access the virtual persona;
record the permissions as a transaction for the MVPT on the DLT;
receive a request from a requestor software application to access the virtual persona on behalf of the first user, including an authenticator generated using the ACKP;
verify the request to access the virtual persona on the DLT by (a) verifying the requestor has permission to access the virtual persona in the permissions and (b) authenticating the authenticator using the ACKP; and
upon verifying the request to access the virtual persona, allow the requestor software application to access the virtual persona.

In another aspect, the virtual persona access system may also include a virtual persona smart contract software program configured to record and control the permissions for the virtual persona. As described above, the virtual persona smart contract software program is software program that binds an authenticated or permission user account with a virtual persona to generate an MVPT, i.e., a tokenized master virtual persona (MVP) which can be accessed by authentication using the ACKP.

In still another aspect, the virtual persona system may also include a real-time virtual persona presence system configured to track real-time use of the virtual persona of the first user, including maintaining a database of software applications actively using the virtual persona (including the actions and behaviors of the virtual persona). In still another aspect, the real-time virtual persona presence system may be further configured to coordinate with the virtual persona access system to cross-reference access rights to a plurality of virtual personas that the first user is authorized to use and allows searching of connections across an authorized software application.

In still another aspect, the virtual persona access system may be further configured to allow the first user to define all aspects of the virtual persona via a user interface configured to access the virtual persona and all virtual persona data for the virtual persona, including defining, modifying and adjusting one or more of visual, audio, controls, interactivity, artificial intelligence, permissions, and economic exchanges for the virtual persona.

In additional aspects, the virtual persona system may be configured to include any one or more of the aspects and features of any of the method embodiments described herein.

### BRIEF DESCRIPTION OF THE DRAWINGS

The foregoing and other aspects of embodiments are described in further detail with reference to the accompanying drawings, wherein like reference numerals refer to like elements (e.g., elements having the same number are considered like elements such as 50a and 50b) and the description for like elements shall be applicable for all described embodiments wherever relevant:

FIG. 1 is a block diagram of a virtual persona system, according to one embodiment of the present invention;

FIG. 2 is a block diagram illustrating system and process flow for a method of using the virtual persona system to create and tokenize a virtual persona based on an avatar of a user, according to one embodiment of the present invention;

FIG. 3 is a block diagram illustrating system and process flow for a method of using the virtual persona system to create and tokenize a virtual persona based on a character protected by character intellectual property owned by a CIPO, according to one embodiment of the present invention;

FIG. 4 is a block diagram illustrating system and process flow for a method of configuring intellectual property licensing and display rights for a virtual persona based on a character protected by character intellectual property owned by a CIPO, according to one embodiment of the present invention;

FIG. 5 is a block diagram illustrating system and process flow for a method of configuring permissions for access, use and/or display rights for a virtual persona based on an avatar created by a user according to the method illustrated in FIG. 2, according to one embodiment of the present invention;

FIG. 6 is a block diagram illustrating system and process flow for a method of allowing users to securely access and use a tokenized virtual persona in a third-party software application, according to one embodiment of the present invention;

FIG. 7 is a block diagram illustrating system and process flow for a method of allowing multiple users to have display rights to different virtual personas of a first user in a third-party software application such that each different user simultaneously views the first user as a different virtual persona of the first user in the software application, according to one embodiment of the present invention;

FIG. 8 is a block diagram illustrating a virtual persona container system for storing the virtual personas (i.e., the virtual persona data files) in a digital file storage system of the virtual persona system, according to one embodiment of the present invention; and

FIG. 9 is a block diagram illustrating system and process flow for a method of direct camera capture of authenticated media for use in creating and minting the media with or without a virtual persona as an NFT to create an authenticated original media file, according to one embodiment of the present invention.

### DETAILED DESCRIPTION

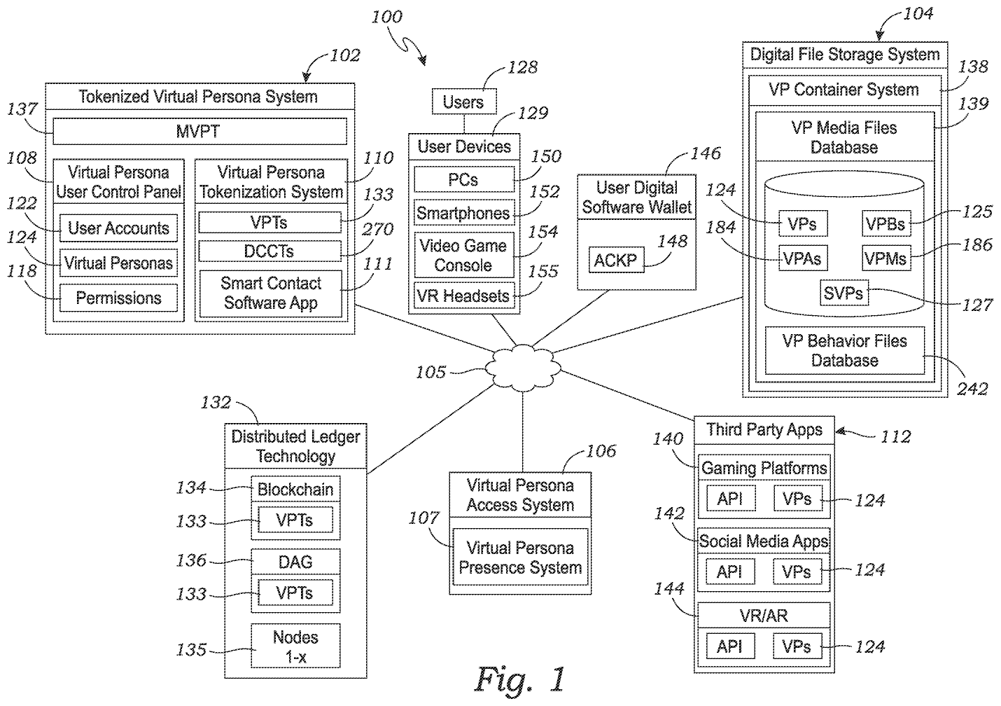

Referring to FIG. 1, one embodiment of a virtual persona system 100 for managing all aspects of virtual personas (also referred to as “VPs”) is shown, including securely: creating virtual personas; encrypting and tokenizing the virtual personas; authorizing software application(s) to access and use the virtual personas; modifying the virtual personas; managing ownership rights to the virtual personas; managing access and usage rights in the virtual personas; providing authorized access and use of the virtual personas; managing the ability of character intellectual property owners to create and license virtual personas based on proprietary characters; and additional functionality as described herein. The virtual persona system 100 comprises one or more computing systems hosting software applications configured to provide the described functionality of the system 100. The computing systems each comprise one or more computer processors, memory, and one or more storage devices. The virtual persona system 100 may be configured as a cloud computing system, for example, to provide the virtual persona management using a software as a service (SAAS) approach. Alternatively, the virtual persona system 100 may be a stand-alone computing system accessible via a computer communication network 105, or peer-to-peer decentralized system of individual computer systems known as nodes using DLT, which may include one or more of the internet, a local area network (LAN), a wide area network (WAN), a cellular communication network, and/or other communication network.

As shown in FIG. 1, the virtual persona system 100 includes a tokenized virtual persona system 102, a digital file storage system 104, and a virtual persona access system 106. The tokenized virtual persona system 102 is configured to allow users to create user accounts 122 and virtual personas 124, configure permissions 126 defining usage rights for the virtual personas 124, tokenize the virtual personas 124 into VPTs 133 and record the VPTs 133 on a DLT 132, as described in more detail herein. The tokenized virtual persona system 102 includes a virtual persona user control panel 108 and a virtual persona tokenization system 110. The virtual persona user control panel 108 is configured to allow a user 128 to create and modify virtual personas 124, and to allow a user 128 to configure permissions 118 defining usage rights (i.e., access and use rights) for the virtual personas 124 to third-party software applications 112 and other users 128. Each user 128 may access and utilize the virtual persona system 100 using a respective user computing device 129, such as a personal computer (PC) 150, smartphone 152, video game console 154, VR or AR headset 155, or other suitable computing device. The virtual persona tokenization system 110 is configured to generate tokens (i.e., tokenize) of the virtual personas 124, called virtual persona tokens (VPTs) 133 by associating the virtual personas 124 and/or permissions 118 with respective user accounts 122 as respective NFTs. The permissions 118 may be tokenized as separate non-fungible or semi-fungible tokens and recorded on the DLT 132 to make record of the ownership and usage rights defined by the tokens. The virtual tokenization system 110 is also configured to record the VPTs 133, such as an MVPT 137 or SVPT 131, on a DLT 132. The virtual persona system 100 may also use cryptographic payments tokens that are used on the DLT 132 to exchange monetary value for usage rights and/or license rights granted in the virtual personas 124, and/or for goods and services.

The DLT 132 may be any suitable blockchain technology 134 or directed acyclic graph (DAG) technology 136. The DLT 132 may comprise a series of computer 1-X node(s) 135 that provide a distributed system of authorizing, recording and maintaining all transactions for the virtual persona system 100. The DLT 132 may rely on other databases or ledgers that are separate from the DLT 132. In such cases, mechanisms are implemented to assure the DLT 132 remains the master ledger of record for the virtual persona system 100.

The virtual tokenization system 110 includes a smart contract software application 111 configured to tokenize a virtual persona 124 by associating the virtual persona to a respective user account 122 as an NFT, thereby generating a VPT 133.

The digital file storage system 104, also referred to as a “permissioned digital file storage system” (PDFSS) is configured to securely store the virtual personas 124 using a virtual persona container system 138 and to provide authorized access to the virtual personas 124 stored therein in response to requests from the third-party software applications 112. The virtual persona container system 138 may utilize a VP media files database 139 and/or VP behaviors database 242, which may be any suitable relational database system.

The third-party software applications 112 may be any suitable application which utilizes a virtual persona 124, such as gaming platforms/applications 140, social media applications 142, and VR/AR applications 144. Each of the software applications 112 includes API 146 configured to interface with the virtual persona system 100 to allow an authorized user to access and use the virtual personas 124 created and managed on the virtual persona system 100 within the software application 112.

The virtual persona access system 106 is configured to receive and verify requests from the software applications 112 to access and use the virtual personas 124, and upon verifying a request, provide access to the virtual personas 124, as described in more detail herein. The virtual persona access system 106 may also include a real-time virtual persona presence system 107. The virtual persona presence system 107 is configured to track real-time use of the virtual personas 124 in the virtual persona system 100 and maintains a database of software applications 112 actively using each of the virtual personas 124. The virtual persona presence system 107 may also be configured to coordinate with the virtual persona access system 106 to cross-reference access rights to a plurality of virtual personas 124 that each user 128 is authorized to use and allows searching of connections across an authorized software application 112.

The virtual persona system 100 also includes user digital software wallets 146 which each store a respective unique ACKP 148 for each user 128. The digital software wallets 146 are password-secured by each user 128, which may also include multi-factor authentication.

The systems and components of the virtual persona system 100 can communicate with each other via one or more communication networks 105. The one or more communication networks 105 may include one or more of the internet, a local area network (LAN), a wide area network (WAN), a cellular communication network, and/or other communication network.

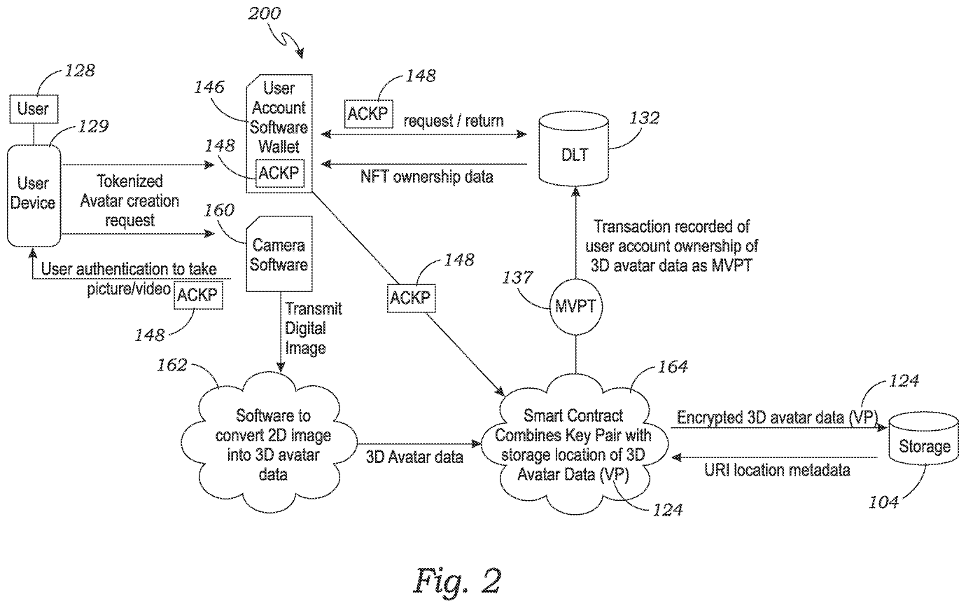

Referring now to FIG. 2, the schematic diagram illustrates an exemplary method 200 of using the virtual persona system 100 to create and tokenize a virtual persona 124 based on an avatar of a first user 128. As shown in FIG. 1 and described herein, the virtual persona system 100 securely creates a first user account 122 for the first user 128 by authenticating an identity of the first user 128 by transmitting an authentication message to a messaging address provided by the first user 128. The messaging address may be a mobile phone number or an email address of the user 128, wherein the authentication message is a text message transmitted to the mobile phone number or an email sent to the email address. The first user 128 must respond to the authentication message with an authenticating response which is received by the virtual persona system 100 in response to the authentication message. The virtual persona system 100 creates a first user account 122 registered on the DLT 132, creates an authorized and password-secured digital wallet 146 for the first user 128, generates a unique first ACKP 148 for the first user 128 and registers the first ACKP 148 in the digital wallet 146 of the first user 128.

As shown in FIG. 2, the virtual persona system 100 receives from the first user 128 a request to create a virtual persona 124 based on an avatar. The first user 128 provides a user authentication, which may use the first ACKP 148, to take a picture or video using camera software 160 which may be on the first user's device 129 or separate camera (not shown). A picture or video is taken of the first user 128 (or other person, animal, or object) producing a 2D digital image, such as a digital photo or digital video. The digital image is transmitted to the virtual persona system 100. At step 162, a software application on the virtual persona system 100 converts the 2D digital image into 3D digital avatar data to create a virtual persona base (VPB) 125, which includes the base digital file(s) which form the virtual persona 124. The VPB 125 is then configured into a virtual persona 124 using the virtual persona user control panel 108. The virtual persona 124 is encrypted and stored at a storage location (which may be indicated by URI location metadata) in the VP media files database 139.

At step 164, the 3D digital avatar data is tokenized by the smart contract 111 of the virtual persona tokenization system 110 by generating a MVPT 137 which combines the first ACKP 148 for the first user account 122 with the storage location of the 3D digital avatar data as an NFT. The MVPT 137 may also be non-tradeable, as well as non-fungible. The virtual persona tokenization system 110 records the MVPT 137 on the DLT 132. The ownership data for MVPT 137 is also recorded in the first user's digital wallet 146 by a transaction verified using the first ACKP 148, such as by an ACKP exchange or digital signature generated using the ACKP 148.

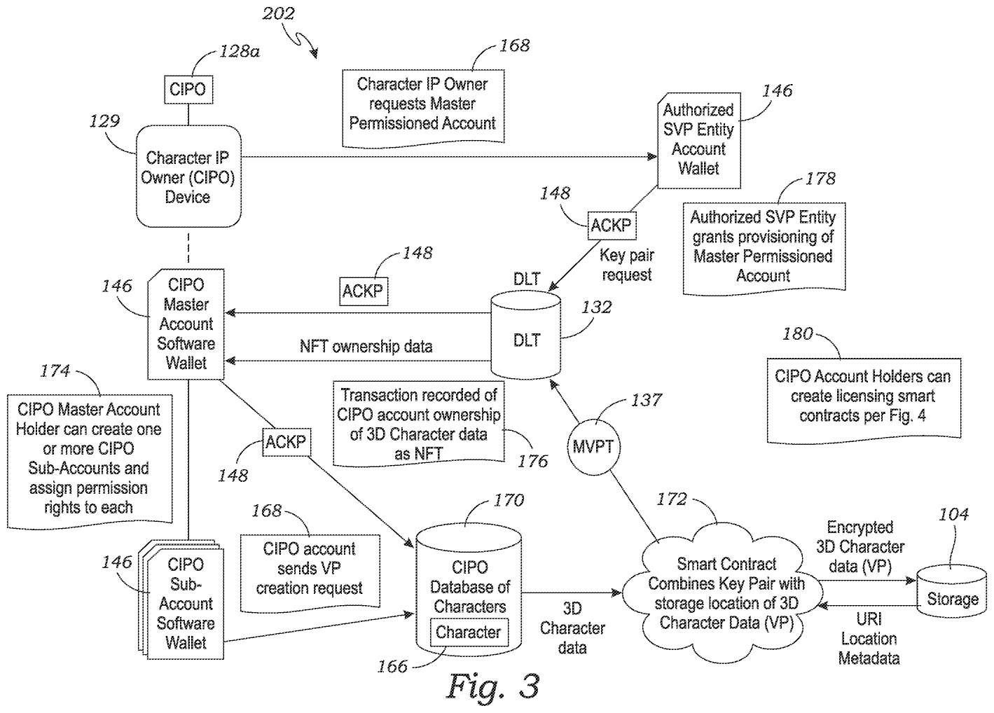

Turning to FIG. 3, a schematic diagram for an exemplary method 202 of using the virtual persona system 100 to create and tokenize a virtual persona 124 based on a character 166 protected by character intellectual property owned by a CIPO 128a is illustrated. The character 166 may be stored in a CIPO database 170 of characters 166. The character 166 may comprise 3D character data including appearance attributes and physical attributes, as well as data representing sound traits, capability traits and personality traits for the characters. The method 202 is similar to the method 200, except that in the method 202 the user 128 is a CIPO 128a, and the virtual persona 124 is based on a character 166 instead of a digital image from the user 128. Hence, in the method 202, at step 168, the virtual persona system 100 receives a request from the CIPO 128a to create a master permissioned account 122. The virtual persona system 100 creates the master permissioned account 122 in the same or similar manner as described above for creating the first user account 122, which may also include the user. The virtual persona system 100 creates a CIPO account 122 registered on the DLT 132, creates an authorized and password-secured digital wallet 146 for the CIPO 128a, generates a unique CIPO ACKP 148 for the CIPO 128a and registers the CIPO ACKP 148 in the digital wallet 146 of the CIPO 128a.

The CIPO 128a provides a user authentication, which may use the CIPO ACKP 148, to allow the virtual persona system 100 to access the character 166 in the CIPO database 170. The character 166 (i.e., the character data 166 stored in the CIPO database 170) is then accessed by the virtual persona system 100. The character data 166 may be 3D character data useable as a virtual persona 124. If not, a software application on the virtual persona system 100 converts the character 166 into a format useable as a virtual persona 124 on the virtual persona system 100, such as by converting the character 166 into 3D digital avatar data and/or performing any other needed formatting or conversion. The virtual persona 124 is encrypted and stored at a storage location (which may be indicated by URI location metadata) in the VP media files database 139. At step 172, the virtual persona 124 (comprising the character 166) is tokenized by the smart contract 111 of the virtual persona tokenization system 110 by generating a MVPT 137 which combines the CIPO ACKP 148 for the CIPO account 122 with the storage location of the virtual persona 124 as an NFT. The MVPT 137 may also be non-tradeable, as well as non-fungible. The virtual persona tokenization system 110 records the MVPT 137 on the DLT 132. At step 176, the ownership data for MVPT 137 is also recorded in the digital wallet 146 of the CIPO 128a by a transaction verified using the first ACKP 148, such as by an ACKP exchange or digital signature generated using the ACKP 148 of the CIPO 128a.

As shown in FIG. 3, the CIPO 128a may also authorize an SVP entity 128 to access and use the virtual persona 124. In such case, the virtual persona system 100 creates an SVP entity account 122 in the same or similar manner as creating the first user account in the method 200 described above. The virtual persona system 100 creates an SVP entity account 122 registered on the DLT 132, creates an authorized and password-secured digital wallet 146 for the SVP entity 128, generates a unique SVP entity ACKP 148 for the SVP entity 128 and registers the SVP entity ACKP 148 in the digital wallet 146 of the SVP entity 128. At step 178, the CIPO 128a grants the SVP entity account 122 a license to access the virtual persona 124 (e.g., an SVP 127) for the SVP entity 122. The virtual persona tokenization system 110 generates an SVP token 133 (SVPT 131) by associating the license to the virtual persona 124 as an NFT, and records the SVPT 130 as a transaction on the DLT.

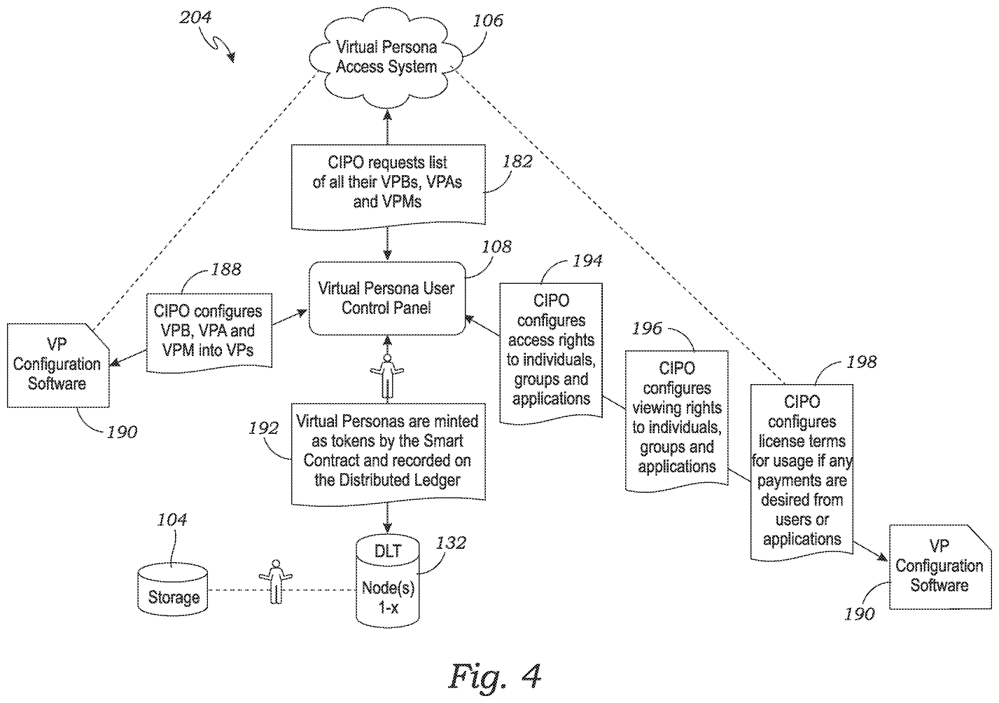

Also shown in FIG. 3, at step 174, the CIPO 128a can create one or more sub-accounts 122 and assign permission rights to each sub-account 122 to access and use the virtual personas 124 of the CIPO. A digital wallet 146 is also created for each respective sub-account 122. In addition, at step 180, the CIPO can create smart licensing contracts, as shown in FIG. 4, and described below.

Turning now to FIG. 4, a method 204 is shown for configuring intellectual property licensing, display rights, and usage rights for a virtual persona created and tokenized according to method 202, in other words, a virtual persona 124 based on a character protected by character intellectual property owned by a CIPO 128a. As shown in FIG. 4, at step 182, the CIPO 128a requests a list of all of the virtual personas 124 in the CIPO account 122, including VPBs 124, VPAs 184 and VPMs 186 (described in more detail below). The virtual persona access system 106 provides the list of all of the virtual personas 124 in the CIPO account 122 to the virtual persona control panel 108. The CIPO 128a can then use the virtual persona control panel 108 to create and modify virtual personas 116, and to allow a user 128 to configure permissions 118 defining usage rights (i.e., access and use rights) for the virtual personas 124 to third-party software applications 112 and other users 128. At step 188, the CIPO can configure a VPB 125, VPA 184 and/or VPM 186 into a virtual person 124 using the VP configuration software 190.

At step 192, the virtual personas 124 are minted as VPTs by the smart contract 111 and recorded on the DLT 132.

In addition, the CIPO 128a can utilize the virtual persona user control panel 108 to configure the permissions 118 for the virtual personas 124 using the VP configuration software 190. As step 194, the CIPO 128a can use the virtual persona user control panel 108 to configure a permission for access and usage rights for individuals (e.g., other users 128), groups, and software applications 112. At step 196, the CIPO 128a can also configure viewing rights for individuals (e.g., other users 128), groups, and software applications. As some examples, the CIPO can define one or more SVPs 127 using the virtual persona control panel 108, and then assign relationships to other users and/or software applications 112 to control who can view the different SVPs 127. The viewing rights can also set a default virtual persona 124 that all users 128 will see for each software application that is granted permission to access and display a virtual persona 124. This can be any of the CIPO's virtual personas 124 that are assigned to the CIPO MVPT 137. The viewing rights can also include an “invisible mode” where the CIPO 128a can participate in a software application 112 without a visible representation of a virtual persona 124. The viewing right can also include a specific virtual persona 124 that will be displayed to a specific user, such as when both users are in a common software application 112. The viewing rights can also assign different virtual personas 124 to each of different users 128. The display of the different virtual personas can be simultaneous such that any and all actions performed by any one of the virtual personas 128a is represented to all participants on a software application 112 without perceived delay.

At step 198, the CIPO 128a can also use the virtual persona user control panel 108 to configure license terms between the CIPO and other users (licensees) for granting the usage rights to the virtual personas 124 of the CIPO 128a. The license terms may include fees to be paid by the licensee, the term of the license, and any other desired terms.

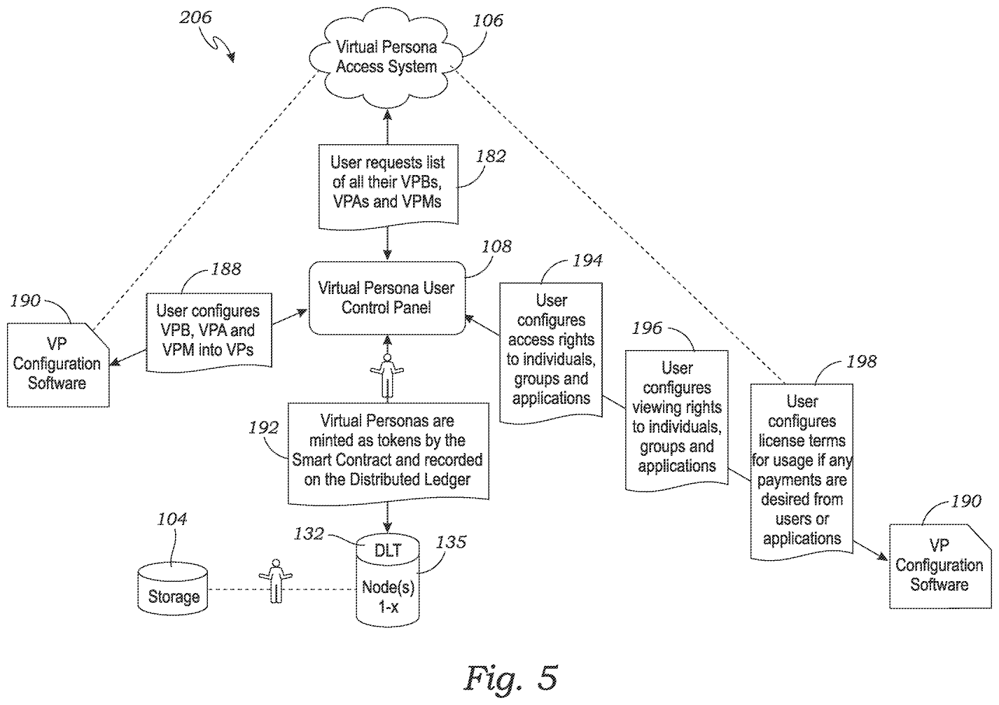

Turning to FIG. 5, a method 206 is shown for configuring intellectual property licensing, display rights, and usage rights for a virtual persona 124 created and tokenized according to method 200, in other words, a virtual persona 124 based on an avatar created by a user 128. The method 206 is substantially the same as the method 204, except that the CIPO 128a in method 204 is replaced by a user 128 in method 206.

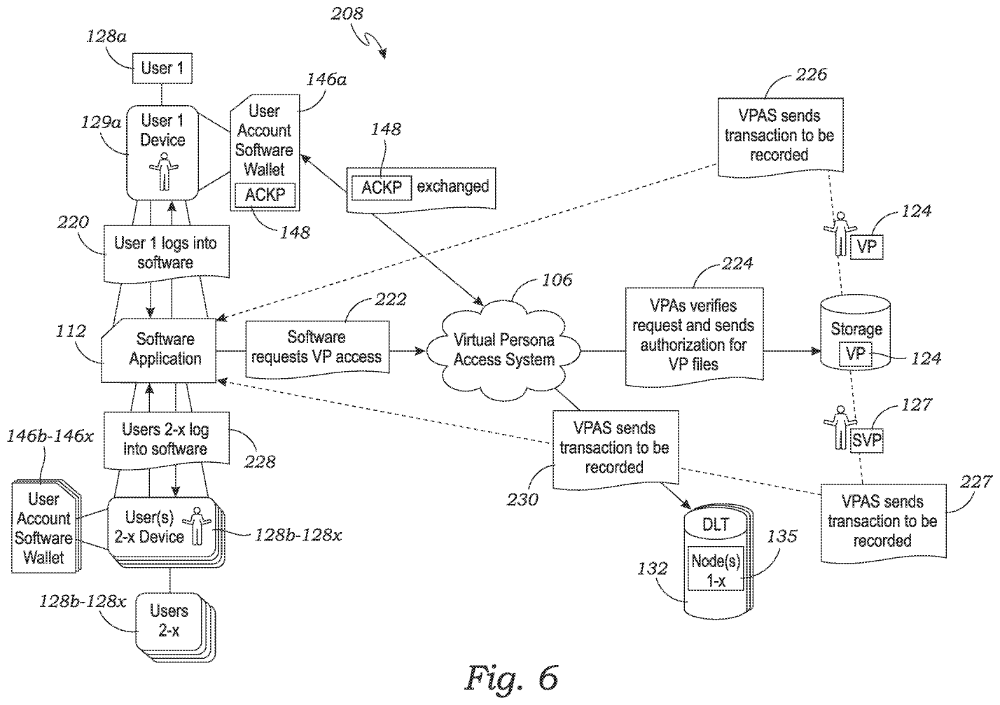

Referring now to FIG. 6, a method 208 is illustrated for accessing and using one or more virtual personas 124 created and tokenized by a first user 128a (referred to as “User 1” in FIG. 6) according to the method 200 and having permissions 118 configured according to the method 206. In the exemplary method 208 shown in FIG. 6, the first user 128a has created one or more virtual personas 124 and tokenized the virtual personas 124 according to the method 200, and the first user 128a has also configured permissions 118 authorizing the software application 112 to access and use the virtual personas 124, and authorizing other users 128b-128x to access and use the virtual personas 124 on the software application 112 and/or granting viewing rights to the other users 128b-128x to view the virtual personas 124 on the software application 112. At step 220, the first user 128a logs into the software application 112 and makes a request to access and use the virtual personas 124 on the software application 112. The request also includes an authenticator using the first user's ACKP 148, such as a digital signature or ACKP exchange with the virtual persona access system 106.

At step 224, the virtual persona access system 106 verifies the request using the DLT by verifying the requestor software application 112 has permission to access the virtual personas 124 in the permissions and authenticating the authenticator using the first user's ACKP 148. Upon verification, the virtual persona access system 106 sends an authorization to the digital file storage system 104 to allow the software application 112 to access the virtual personas 124. At step 226, the virtual persona 124 (i.e., the virtual persona data files) is uploaded or streamed to the software application 112. FIG. 6 also shows that the permissions 118 may grant access, use and/or viewing rights to another virtual persona 124 for the first user 128a, such as an SVP 127. Accordingly, at step 227, another virtual persona 124, such as an SVP 127 (i.e., the SVP data files) is uploaded or streamed to the software application 112.

The virtual persona access system 106 also verifies the permissions 118 authorizing other users 128b-128x to access and use the virtual personas 124 on the software application 112 and/or granting viewing rights to the other users 128b-128x to view the virtual personas 124 on the software application 112, and authorizes the software application 112 to allow the other user 128b-128x to access, use and/or view the virtual personas 124 according to the verified permissions 118. At step 228, one or more of the other users 128b-128x log into the software application 112, and are allowed to access, use and/or view the virtual personas 124 (and/or SVP 127) according to the verified permissions 118.

At step 230, the virtual persona access system 106 sends one or more transactions for the access, use and viewing of the virtual personas 124 allowed on the software application 112 for recording on the DLT 132.

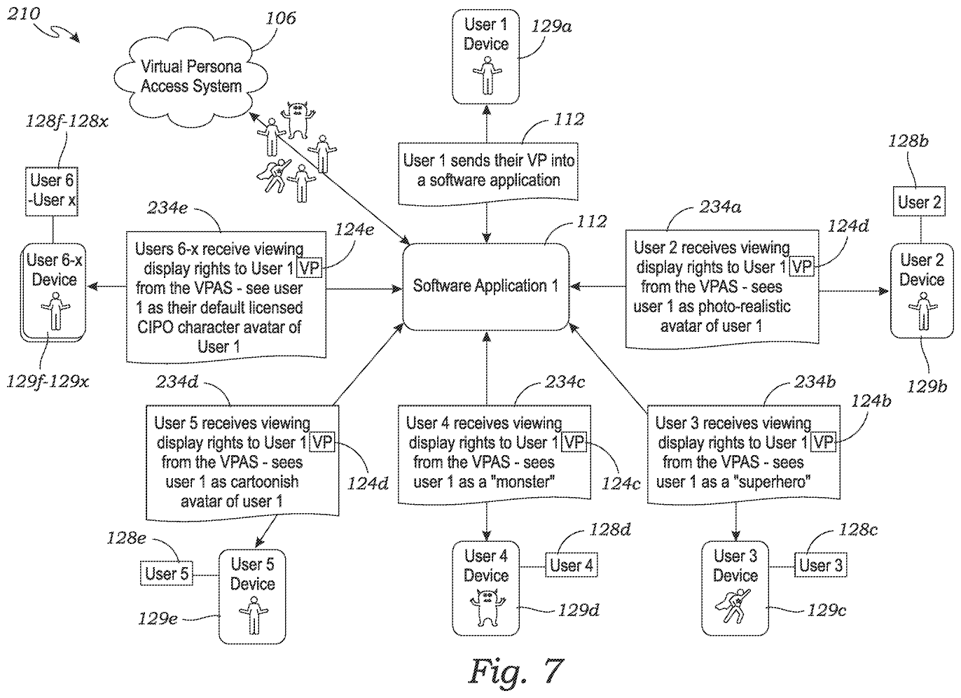

FIG. 7 illustrates a method 210 for allowing a User 1 128a to configure permissions for one or more other users 128b-128x to have display rights to different virtual personas 124 of User 1 128a in a third-party software application 112, such that each other user 128b-128x simultaneously views the User 1 128a as a different virtual persona 124 of User 1 in the software application 112. In the method 210, the User 1 128a has created a plurality of virtual personas 124a-124x and tokenized the virtual personas 124 according to the method 200. One or more of the virtual personas 124a-124x may be SVPs 127, which may be formed using VPAs 184 and/or VPMs 186. For example, a virtual persona 124a is a photo-realistic avatar of User 1 128a which may use any combination of VPAs 184 and VPMs 186, a virtual persona 124b is a superhero avatar, a virtual persona 124c is a monster avatar, a virtual persona 124d is a cartoonish avatar of User 1 128a which may use any combination of VPAs 184 and VPMs 186, and a virtual persona 124e is a default licensed CIPO character avatar of User 1 128a which may use any combination of VPAs 184 and VPMs 186. User 1 128a has also configured different permissions 118 for each of the virtual personas authorizing the software application 112 to access and use the virtual personas 124a-124x, and assigning different viewing display rights on the software application 112 to the various other users 128b-128x. For example, User 2 128b is assigned viewing display rights to virtual persona 124a, User 3 128c is assigned viewing display rights to virtual persona 124b, User 4 128d is assigned viewing display rights to virtual persona 124c, User 5 128c is assigned viewing display rights to virtual persona 124d, and User 6—User x are assigned viewing display rights to virtual persona 124e.

At step 232, User 1 128a logs into the software application 112, and the software application 112 requests to access and use the virtual personas 124a-124e, as described in method 208. The virtual persona system 100 verifies the request, and provides access to the virtual personas 124a-124e, as also described in method 208. At steps 234a-234e, the software application 112 simultaneously displays the respective virtual persona 124a-124e assigned to each respective other user 128b-128x. Accordingly, User 2 128b sees User 1 128a as the photo-realistic avatar of User 1 128a, while User 3 128c sees User 1 128a as the superhero, while User 4 128d see User 1 128a as the monster, while User 5 128e sees User 1 128a as the cartoonish avatar of User 1 128a, and User 6 128f—User X 128x see User 1 128a as the default licensed CIPO character avatar of User 1 128a.

The method 210 may also include any one or more of the processes utilized in the method 208.

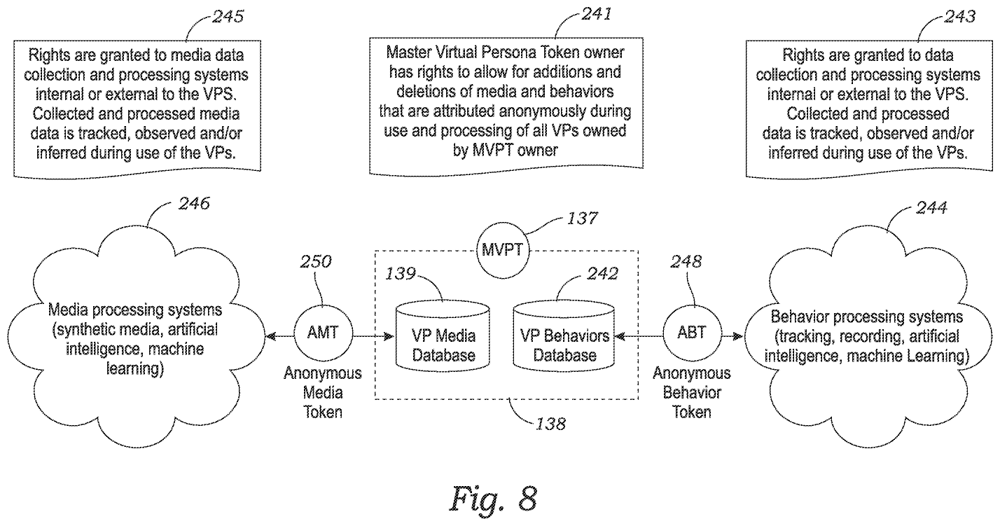

FIG. 8 illustrates one exemplary embodiment of the virtual persona container system 138 for storing the virtual personas 124, SVPs 127, VPBs 125, VPAs 184 and/or VPMs 186 in the digital file storage system 104 of the virtual persona system 100. The container system 138 comprises a virtual persona files database including a VP media database 139 and a VP behaviors database 242. In this way, the VP media database 139 contains the media files for the virtual personas 124 stored therein, and the VP behaviors database 242 stores the data files for the capability traits and personality traits for the virtual personas stored therein. At step 241, the container system 138 the owner of the MVPT 137 can make additions and deletions of media and behaviors that are attributed anonymously during use and processing of all virtual personas 124 owned by the owner of the MVPT 137. At step 243, rights are granted to data collection and processing systems internal or external to the virtual persona system 100. The collected and processed data is tracked, observed and/or inferred during use of the virtual personas 124. Behavior processing systems 244 are used to track and record the behavior data, and may use artificial intelligence and/or machine learning. The behavior processing systems 244 generate an anonymous behavior token 248 which is then stored in the VP behaviors database 242. Similarly, at step 245, rights are granted to media data collection and processing systems internal or external to the virtual persona system 100. The collected and processed media is tracked, observed and/or inferred during use of the virtual personas 124. Media processing systems 246 are used to generate synthetic media, and may use artificial intelligence and/or machine learning. The media processing systems 246 generate an anonymous media token 250 which is then stored in the VP media database 139.

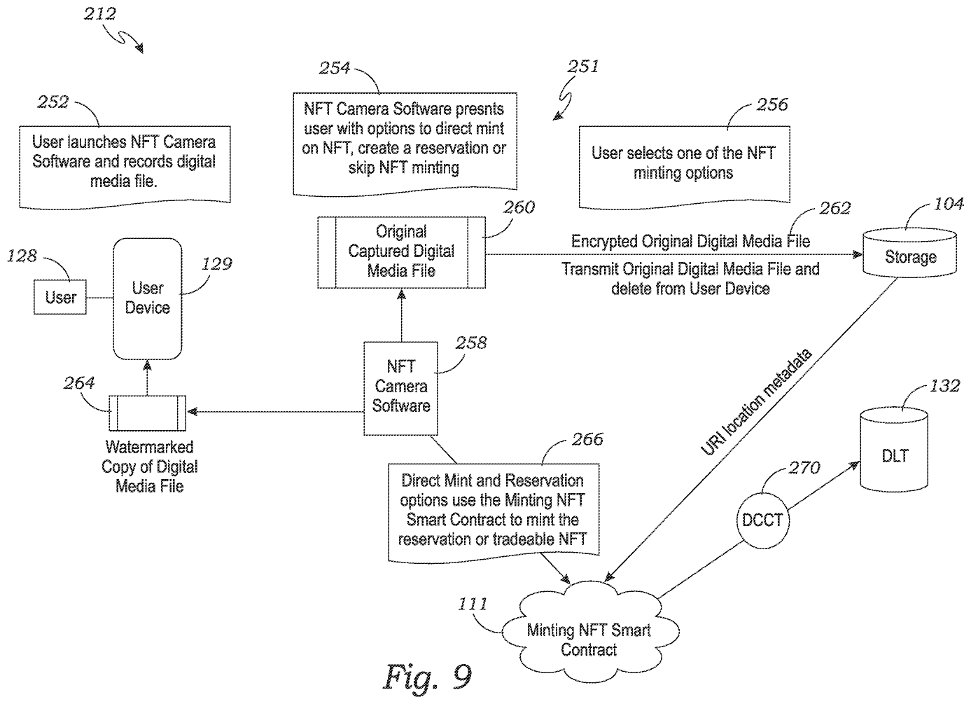

FIG. 9 illustrates an NFT camera reservation and direct minting system 251, and a method 212 of using the system 251 for direct camera capture of authenticated media (which may or may not be used in creating a virtual persona 124), and tokenizing the media as an NFT to create a direct camera capture token 270. The NFT camera reservation and direct minting system 251 allows a user 128 to create digital media consisting of photos, videos and 3D objects from a user device's camera and turn them into an NFT, such as a DCCT 260. As shown in FIG. 9, at step 252, a user 128 launches an NFT camera software application 258 on the user device 129. The NFT camera software application can be added to any device that has a digital camera. The NFT camera software application is configured to convert a digital media file into a cryptographic token, such as a DCCT 270, that contains the original digital media file created by the camera. The user's device captures an image of the desired subject matter as a digital media file 260. At step 254, the NFT camera software application presents the user 128 with the option to directly mint an NFT, create a reservation or skip NFT minting. At step 256, the user selects one of the NFT minting options. A first option is a direct mint option. In the direct mint option, at step 262, the original digital media file 260 is encrypted and transferred to the permissioned digital file storage system 104. At step 264, the local copy of the digital media file is marked with a watermark that notates it as a copy of the original digital media file 260 which may be a lower quality version than the original. At step 266, the smart contract 111 mints an NFT (e.g., a DCCT 270) with the URI location metadata of the storage location of the original digital media file 260 in the digital file storage system 104. The smart contract 111 records the NFT (e.g., a DCCT 270) on the DLT 132. The local original quality version of the digital media file 260 is then permanently deleted from the user device 129.

A second option is a mint reservation option. In the mint reservation option, at step 262, the original digital media file 260 is encrypted and transferred to the permissioned digital file storage system 104. At step 264, the local copy of the digital media file 260 is marked with a watermark that notates it as a copy of the original digital media file which may be a lower quality version than the original. At step 266, the smart contract 111 mints the NFT (e.g., a DCCT 270) as a reservation without the ability to transfer ownership of the NFT (e.g., a DCCT 270) and records the information on the DLT 132. The local original quality version of the digital media files is permanently deleted from the user device 129. If the user chooses at a later time to mint the NFT (e.g., a DCCT 270) as a tradeable NFT (e.g., a DCCT 270), it is converted to a direct mint NFT (e.g., a DCCT 270). If the user chooses at a later time to cancel the reservation, the original quality digital media file is transferred from the digital file storage system 104 to be used as an openly available digital media file.

Although particular embodiments have been shown and described, it is to be understood that the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, not all of the components and/or method steps described in the embodiments are necessary, and the invention may include any suitable combinations of the described components and method steps. Accordingly, embodiments are intended to exemplify alternatives, modifications, and equivalents that may fall within the scope of the claims. The invention, therefore, should not be limited, except to the following claims, and their equivalents.

What is claimed is:

1. A method for generating and using a tokenized virtual persona, the method comprising:
creating a virtual persona for a first user, the virtual persona comprising one or more of appearance attributes, physical attributes, sound traits, capability traits and personality traits for the virtual persona;
associating the virtual persona with a unique first user account having an associated unique authorized cryptographic key pair (ACKP);
encrypting the virtual persona;
storing the encrypted virtual persona at a storage location within a virtual persona files database;
generating a master virtual persona token (MVPT) for the virtual persona by associating the virtual persona to the first user account as a non-fungible token (NET); and
recording the MVPT on a distributed ledger technology (DLT) configured to track ownership rights to the virtual persona;
configuring one or more permissions defining usage rights for the virtual persona, the permissions including one or more application permissions authorizing one or more of a plurality of software applications to access and use the virtual persona; and
recording the application permissions as a transaction for the MVPT on the DLT.

2. The method of claim 1, further comprising:
receiving a request from a requestor software application to access the virtual persona on behalf of the first user, the request including an authenticator generated using the ACKP;
verifying the request to access the virtual persona using the DLT by (a) verifying the requestor software application has permission to access and use the virtual persona in the permissions and (b) authenticating the authenticator using the ACKP; and
upon verifying the request to access the virtual persona, allowing the requestor software application to access the virtual persona and to only use the virtual persona as set forth in the permissions.

3. The method of claim 2, wherein access to the virtual persona is provided by one of uploading, downloading or streaming the virtual persona to the requestor software application.

4. The method of claim 2, wherein the virtual persona is uploaded, downloaded or streamed to the requestor in encrypted packets for rendering in real-time by the requestor without providing storage of the virtual persona.

5. The method of claim 2, further comprising:
recording a transaction on the DLT for allowing the requestor software application to access the virtual persona.

6. The method of claim 1, wherein a smart contract generates the MVPT by associating the virtual persona to the first user account.

7. The method of claim 1, further comprising:
creating the first user account by a process comprising:
authenticating an identity of the first user by transmitting an authentication message to a messaging address provided by the first user, and receiving an authenticating response from the first user in response to the authentication message;
generating the ACKP in response to receiving the authenticating response; and
creating an authorized digital account wallet for the first user and registering the ACKP in the digital account wallet of the first user.

8. The method of claim 7, wherein the messaging address is one of a mobile phone number and an email address, and the authentication message is one of a text message transmitted to the mobile phone number and an email sent to the email address.

9. The method of claim 7, wherein the process for creating the first user account further comprises:
verifying that the first user is a real person using a live image detection on a real-time photo capture device to eliminate fake users, including bots, and to prevent plagiarism of another user's identity.

10. The method of claim 9, wherein the live image detection comprises one of a single image, passive facial liveness detection or other suitable method of verifying liveness.

11. The method of claim 1, wherein the DLT is selected from the group consisting of: blockchain technology; and directed acyclic graph (DAG) technology.

12. The method of claim 1, wherein creating the virtual persona comprises:
receiving a digital image of the user from the first user, the digital image being one of a digital photo, a digital video and a digital scan; and
converting the digital image into three-dimensional avatar data thereby forming a virtual persona base (VPB), wherein the VPB includes base digital files for constructing the virtual persona, including one or more of appearance attributes, physical attributes, sound traits, capability traits and personality traits for the virtual persona.

13. The method of claim 12, wherein creating the virtual persona further comprises:
adding a virtual persona attribute (VPA) to the virtual persona, wherein the VPA is one or more of a digital object and data to change one or more of appearance attributes, physical attributes, sound traits, capability traits and personality traits for the virtual person; and
wherein the VPA is directly controllable only by an owner of the MVPT, user(s) authorized by the owner of the MVPT, and software applications authorized by the permissions.

14. The method of claim 13, further comprising:
generating a virtual persona attribute token by associating the VPA to the first user account as an NFT which documents ownership of the virtual persona attribute token by the first user; and
registering the virtual persona attribute token on the DLT.

15. The method of claim 12, wherein creating the virtual persona further comprises:
adding a virtual persona modification (VPM) to the virtual persona;
wherein the VPM is one or more of a digital object and data to change one or more of appearance attributes, physical attributes, sound traits, capability traits and personality traits for the virtual persona; and
wherein the VPM can be used only as authorized by the first user.

16. The method of claim 15, further comprising:
generating a virtual persona modification token by associating the VPM to the first user account as an NFT, the virtual persona modification token having no mathematical relationship to the VPA; and
registering the virtual persona modification token on the DLT.

17. The method of claim 1, wherein creating the virtual persona comprises:
capturing a digital image of a two-dimension or three-dimension source selected from the group consisting of a photo, a video, a real-world animate object and a real-world inanimate object;
converting the digital image into three-dimensional avatar data thereby forming a virtual persona base (VPB).

18. The method of claim 17, wherein the digital image is captured by digital scanning, computer vision or other suitable image capturing process which converts the source into a digital image file.

19. The method of claim 1, wherein creating the virtual persona comprises:
using a computer design software application to produce a set of digital files representing one or more of the appearance attributes, physical attributes, sound traits, capability traits and personality traits for the virtual persona.

20. The method of claim 19, wherein the computer design software application is one of manually operated by a user, semi-automated by user input and automated generation, and fully automated without user input.

21. The method of claim 1, further comprising:
creating a sub virtual persona (SVP) for the first user separate from the virtual persona, the SVP comprising one or more of appearance attributes, physical attributes, sound traits, capability traits and personality traits for the SVP;
associating the SVP with the first user account;
encrypting the SVP;
storing the encrypted SVP in the virtual persona media files database;
configuring one or more permissions defining usage rights for the SVP, the permissions including one or more application permissions authorizing one or more of a plurality of software applications to access and use the SVP; and
registering the SVP and its application permissions within the MVPT on the DLT.

22. The method of claim 21, further comprising:
creating a virtual persona attribute (VPA) comprising a digital object or data which can be added to the virtual persona or the SVP to change one or more of the appearance, sound, actions, and intelligence of the virtual persona or SVP via direct control of the first user and any software application authorized by the permissions, wherein the VPA is owned by the first user; and
registering the VPA within the MVPT on the DLT.

23. The method of claim 21, further comprising:
creating a virtual persona modification (VPM) comprising a digital object or data which can be added to the virtual persona or the SVP to change one or more of their appearance, sound, actions, and intelligence via any means authorized by the permissions, wherein the VPM is not owned by the first user; and
registering the VPM within the MVPT on the DLT.

24. The method of claim 1, further comprising:
configuring a first permission of the one or more permissions to authorize a second user to use the virtual persona, the second user having a unique second user account having an associated unique second ACKP;
recording the first permission as a transaction on the DLT;
receiving a request from a requestor software application to access the virtual persona on behalf of the second user, the request including an authenticator generated using the second ACKP; and
verifying the request to access the virtual persona using the DLT by verifying the requestor software application has permission to access the virtual persona in the permissions, and authenticating the authenticator using the second ACKP.

25. The method of claim 1, wherein the first user is a character intellectual property owner (CIPO) that owns intellectual property rights in a character and the first user account is a CIPO account of the CIPO, and wherein creating the virtual persona comprises:
receiving a request from the CIPO account to create the virtual persona;
authenticating the request from the CIPO account using the ACKP;
receiving character data for the character comprising one or more of appearance attributes, physical attributes, sound traits, capability traits and personality traits for the character; and
creating the virtual persona using the character data.

26. The method of claim 25, further comprising:
creating the CIPO account by a process comprising:
authenticating an identity of the CIPO by transmitting an authentication message to a messaging address provided by the CIPO, and receiving an authenticating response from the CIPO in response to the message;
generating the ACKP in response to receiving the authenticating response; and
creating an authorized digital account wallet for the CIPO and registering the ACKP in the digital account wallet of the CIPO.

27. The method of claim 26, wherein the messaging address is one of a mobile phone number and an email address, and the authentication message is one of a text message transmitted to the mobile phone number and an email sent to the email address.

28. The method of claim 26, further comprising:
configuring a permission to grant access rights to the virtual persona to a second user, wherein the second user has a unique second user account having an associated unique second ACKP;
receiving a request from a requestor software application to access the virtual persona on behalf of the second user, the request including an authenticator generated using the second ACKP;
verifying the request to access the virtual persona using the DLT by (a) verifying the requestor has permission to access and use the virtual persona in the permissions and (b) authenticating the authenticator using the second ACKP; and
upon verifying the request to access the virtual persona, allowing the requestor software application to access the virtual persona and to only use the virtual persona as set forth in the permissions.

29. The method of claim 28, wherein the virtual persona is a sub virtual persona (SVP) created by the CIPO.

30. The method of claim 29, wherein the SVP is created by using at least one of the following processes: (1) creating a virtual persona attribute (VPA) comprising a digital object or data which can be added to the virtual persona or the SVP to change one or more of the appearance, sound, actions, and intelligence of the virtual persona or SVP via direct control of the first user or any software application authorized by the permissions, wherein the VPA is owned by the first user, and using the VPA to create the SVP; and (2) creating a virtual persona modification (VPM) comprising a digital object or data which can be added to the virtual persona or the SVP to change one or more of their appearance, sound, actions, and intelligence via any means authorized by the permissions, wherein the VPM is not owned by the first user, and using the VPM to create the SVP.

31. The method of claim 1, further comprising:
creating a sub virtual persona (SVP) entity account and generating an SVP ACKP associated with the SVP entity account;
creating an authorized SVP entity account wallet and registering the SVP ACKP in the SVP entity account wallet;
granting the SVP entity account access and use rights to the virtual persona for the first user;
generating a SVP token (SVPT) by associating the access rights to the virtual persona as a non-fungible token; and
recording the SVPT as a transaction on the DLT.

32. The method of claim 31, wherein granting the SVP entity account access rights to the virtual persona for the first user comprises:
configuring a permission granting access rights to the virtual persona to the SVP entity account.

33. The method of claim 32, wherein the SVPT is generated by a smart contract which combines the SVPT ACKP with the storage location.

34. The method of claim 1, wherein configuring the one or more permissions further includes one or more of: authorizing one or more other users to access and use the virtual persona and configuring access rights, usage rights and restrictions on use for the one or more other users; and authorizing the one or more other users to view the virtual persona and configuring the viewing rights and restrictions for the one or more other users.

35. The method of claim 34, further comprising:
configuring license terms for the access rights, usage rights and viewing rights granted to the one or more other users, including one or more of: amount of payment; and term of the license.

36. A method for generating and using a tokenized virtual persona, the method comprising:
creating a virtual persona utilizing character data for a character owned by a character intellectual property owner (CIPO), the virtual persona comprising one or more of appearance attributes, physical attributes, sound traits, capability traits and personality traits for the virtual persona;
associating the virtual person with a unique CIPO account having an associated unique authorized cryptographic key pair (ACKP);
encrypting the virtual persona;
storing the encrypted virtual persona at a storage location within a virtual persona media database;
generating a master virtual persona token (MVPT) of the virtual persona by associating the virtual persona to the CIPO account as a non-fungible token (NFT);
recording the MVPT as a transaction on a distributed ledger technology (DLT) configured to track ownership rights to the virtual persona;
configuring a license to a first user to access and use the virtual persona;
recording the license for the first user as a transaction for the MVPT on the DLT;
receiving a request from a requestor software application to access the virtual persona on behalf of the first user, including an authenticator generated using the ACKP;
verifying the request to access the virtual persona on the DLT by verifying the first user has permission to access the virtual persona in the license, and authenticating the authenticator using the ACKP; and
upon verifying the request to access the virtual persona, allowing the requestor access to the virtual persona.

37. The method of claim 36, wherein access to the virtual persona is provided by one of uploading or streaming the virtual persona to the requestor.

38. The method of claim 37, wherein the virtual persona is uploaded or streamed to the requestor in encrypted packets for rendering in real-time by the requestor without providing storage of the virtual persona.

39. The method of claim 36, further comprising:
recording a transaction on the DLT for allowing the requestor software application to access the virtual persona.

40. The method of claim 36, wherein a smart contract generates the MVPT by associating the virtual persona to the CIPO account.

41. The method of claim 36, wherein the character data comprises one or more of appearance attributes, physical attributes, sound traits, capability traits and personality traits for the character, the method further comprising:
receiving a request from the CIPO account to create the virtual persona;
authenticating the request from the CIPO account using the ACKP; and
receiving the character data.

42. The method of claim 41, further comprising:
creating the CIPO account by a process comprising:
authenticating an identity of the CIPO by transmitting an authentication message to a messaging address provided by the CIPO, and receiving an authenticating response from the CIPO in response to the message;
generating the ACKP in response to receiving the authenticating response; and
creating an authorized digital account wallet for the CIPO and registering the ACKP in the digital account wallet of the CIPO.

43. The method of claim 42, wherein the messaging address is one of a mobile phone number and an email address, and the authentication message is one of a text message transmitted to the mobile phone number and an email sent to the email address.

44. The method of claim 36, wherein the virtual persona is a sub virtual persona (SVP) created by the CIPO.

45. The method of claim 44, wherein the SVP is created by using at least one of the following processes: (1) creating a virtual persona attribute (VPA) comprising a digital object or data which can be added to the virtual persona or to the SVP to change one or more of the appearance, sound, actions, and intelligence of the virtual persona or SVP via direct control of the first user and any software application authorized by the permissions, wherein the VPA is owned by the first user, and using the VPA to create the SVP; and (2) creating a virtual persona modification (VPM) comprising a digital object or data which can be added to the virtual persona or to the SVP to change one or more of their appearance, sound, actions, and intelligence via any means authorized by the permissions, wherein the VPM is not owned by the first user, and using the VPM to create the SVP.

46. The method of claim 36, further comprising:
creating a sub virtual persona (SVP) entity account and generating an SVP ACKP associated with the SVP entity account;
creating an authorized SVP entity account wallet and registering the SVP ACKP in the SVP entity account wallet;
granting the SVP entity account a license to access the virtual persona for SVP entity;
generating a SVP token (SVPT) by associating the license to the virtual persona as a non-fungible token (NFT); and
recording the SVPT as a transaction on the DLT.

47. The method of claim 46, wherein the SVPT is generated by a smart contract which combines the SVPT ACKP with the storage location.

48. A system for generating and using a tokenized virtual persona, the system comprising:
a tokenized virtual persona system comprising:
a virtual persona user control panel configured to:
create a virtual persona for a first user, the virtual persona comprising one or more of appearance attributes, physical attributes, sound traits, capability traits and personality traits for the virtual persona;
associate the virtual persona with a unique first user account having an associated unique authorized cryptographic key pair (ACKP); and
encrypt the virtual persona;
configure permissions defining usage rights for the virtual persona, the permissions including authorizing one or more of a plurality of software applications to access the virtual persona;
a virtual persona tokenization system configured to:
generate a master virtual persona token (MVPT) of the virtual persona by associating the virtual persona and permissions to the first user account as a non-fungible token (NET);
record the MVPT on a distributed ledger technology (DLT) configured to track ownership rights to the virtual persona; and
record the permissions as a transaction for the virtual persona MVPT on the DLT;
a virtual persona container system configured to store the encrypted virtual persona at a storage location within a virtual persona files database; and
a virtual persona access system configured to:
receive a request from a requestor software application to access the virtual persona on behalf of the first user, including an authenticator generated using the ACKP;
verify the request to access the virtual persona on the DLT by (a) verifying the requestor has permission to access the virtual persona in the permissions and (b) authenticating the authenticator using the ACKP; and
upon verifying the request to access the virtual persona, allow the requestor software application to access the virtual persona.
receive a request from a requestor software application to access the virtual persona on behalf of the first user, including an authenticator generated using the ACKP;
verify the request to access the virtual persona on the DLT by (a) verifying the requestor has permission to access the virtual persona in the permissions and (b) authenticating the authenticator using the ACKP; and
upon verifying the request to access the virtual persona, allow the requestor software application to access the virtual persona.

49. The system of claim 48, wherein the virtual persona access system further comprises:
a virtual persona smart contract software program configured to record and control the permissions for the virtual persona.

50. The system of claim 49, further comprising:
a real-time virtual persona presence system configured to track real-time use of the virtual persona, including maintaining a database of software applications actively using the virtual persona and their actions and behaviors with the software applications.

51. The system of claim 49, wherein the real-time virtual persona presence system is further configured to coordinate with the virtual persona access system to cross-reference access rights to a plurality of virtual personas that the first user is authorized to use and allows searching of connections across an authorized software application.

52. The system of claim 48, wherein the virtual persona access system is further configured to allow the first user to define all aspects of the virtual persona via a user interface configured to access the virtual persona and all virtual persona data for the virtual persona, including defining, modifying and adjusting one or more of visual, audio, controls, interactivity, artificial intelligence, permissions, and economic exchanges for the virtual persona.
